(19) United States
(12) Patent Application Publication
(10) Pub. No.: US 2009/0158677 A1
(43) Pub. Date: Jun. 25, 2009

(54) Muntin bar clip for colonial and other-style windows

(76) Inventors: Luke Liang, South Plainfield, NJ (US); Toni Liang, Guangzhou (CN); David Chen, Guangzhou (CN)

Correspondence Address: Thomas A. O'Rourke;Bodner & O'Rourke, LLP, 425 Broadhollow Road, Melville, NY, 11747, US

(21) Appl. No.: 12/005,033

(22) Filed: Dec. 24, 2007

(51) Int. Cl. E06B 3/964

(52) U.S. Cl. 52/204.62

(57) ABSTRACT

An improved muntin bar clip for ease of installing bars to the air space of a double-paned window in order to achieve the colonial style window appearance. The clip is configured for one end to be inserted into the frame which provides separation between the lights. The opposite end of the clip points toward the center of the window and provides a quick and easy means of mounting the bars.

### FIELD OF INVENTION

This invention relates to multi-pane windows and doors, and particularly to mounting clips used to support internally contained decorative members to achieve a multi-pane window effect.

### BACKGROUND OF INVENTION

Technological advances in the 11^{th} century AD permitted some of the first glass sheets to be produced, with constant improvement made ever since, including an early 1900s sheet glass drawing machine, which made the mass production of windows possible. Perhaps one of the most notable of recent advances was the development of double pane windows. Single-pane window construction suffered significant thermal losses derived by cold air blowing across the window exterior to create an unhindered heat sink, resulting in windows fogging or frosting, as well as being uncomfortably cold upon contact. Double-pane window construction significantly reduced thermal loss by incorporating a thin layer of trapped air, which is an extraordinarily good insulator when not allowed to convect or otherwise conduct heat away from an object.

A by-product of the double-pane construction method is the ability to utilize the unexposed glass faces, which will never experience ordinary wear from physical contact, for coatings or filters. In addition, the gap itself can serve other uses, most common of which is to accommodate decorative inserts.

Modern styled homes and commercial buildings commonly utilize long uninterrupted sheets of glass, however, many if not most residences and apartment buildings incorporate a multi-pane window or multi-pane door look to achieve a French or colonial style appearance. With single panel construction, this necessitated that either multiple glass panes were in fact utilized, or a faux multi-pane look could be accomplished by attaching a decorative lattice to the interior side of the window or door. This latter approach is still commonly used by window manufacturers, some of whom offer interchangeable grilles that allow purchasers to alternate between various window appearances.

However, double-pane window construction permitted the introduction of the decorative lattice to the air gap between the panes. The vertical and horizontal elements that formed such a lattice on true multi-paned windows were termed muntin bars, and this terminology has similarly been carried over in referring to the vertical and horizontal members trapped within the air gap of double-pane windows and doors.

In constructing multi-paned windows, the window panes are typically separated by insulating material that is wrapped about a hallowed, metallic, frame having a rectangular cross-section. To simplify the manufacturing process and incorporate the decorative inserts, various mounting schemes have been utilized, and often do not use mechanical fasters, but rather involve a clip that is inserted into the metallic frame and serve as a mounting post over which each end of the hallow muntin bar is inserted. This mounting clip is aptly termed a muntin clip. Although existing versions of these clips serve to expedite and simplify construction of multi-paned glass windows, the most functional of these clips exhibits some deficiencies which are addressed by the current invention.

### DESCRIPTION OF THE PRIOR ART

On illustrative example of the prior art can be found in U.S. Pat. No. 5,678,377. The design of the muntin clip is a plastic part composed of a flat base or “body,” and an orthogonal support member called a base flange. Protruding from that same side of the body is a longer slender “central spine” from which extends, at an angle, “bar retaining fingers.” The bar retaining fingers are intended to initially capture and thereafter positionally support the muntin bar. The combination of the finger's length and angular orientation permit the muntin bar to contact the first pair of fingers and depress them to further increase its angular position with respect to the spine, and in so doing, provide pre-load which maintains contact between the bar retaining fingers with the muntin bar. Although functional as to maintaining contact with the muntin bar, the configuration of the clip assembly requires concerted effort to align the end of the muntin bar with the oversized bar retaining finger which has a width before installation slightly greater that the internal dimension of the muntin bar. This is one drawback which is addressed in the current disclosure.

Protruding from the side of the body opposite the base flange, spine, and bar retaining fingers, are a pair of slender hooks referred to as “latching fingers” which are intended to positively retain the clip in contact with the frame, and, therefore, also maintain the position of the muntin bar. However, these fingers are designed with sufficient length to provide flexibility to deflect on installation and then spring back to be captured by a flange of the frame. However, that same flexibility is disadvantageous for retention of the clip in the frame, while trying to install the opposing end of the muntin bar into its respective clip. This drawback of the prior art, along with several other improvements are addressed by the current invention.

### BRIEF SUMMARY OF THE INVENTION

The present invention is intended to be used in conjunction with double-pane windows to provide support for muntin bars located between the panes in order to create a multi-pane look. A metallic frame with generally a C-shaped cross-section, in conjunction with insulating material, is used to provide separation between the window panes. The opening of the C-shaped frame is oriented to face the interior of the window. i.e., the area between the panes. At predetermined intervals along the frame, are pairs of notches in the edges of both sides of the “C”. The respective pair of notches at a frame location additionally appear in the frame directly on the opposite side of the window. The notch locations correspond to the desired placement of a muntin bar. To provide the appearance, for example, that a window is composed of 6 individual panes of glass, would necessitate that one muntin bar run in either the vertical or horizontal direction, and two muntin bars run in the direction perpendicular to the first muntin bar. This 6-pane appearance results in the need for 6 sets of notches, with each set of notches corresponding to one end of each of the muntin bars. Muntin bar attachment is accomplished through use of a muntin clip. The muntin clip of the disclosed invention is configured to attach, without mechanical fasteners, to the C-section frame. Unlike the prior art, this disclosure does not utilize the slender “latching” fingers, but instead uses a rigid overhanging hook to positively attach the clip to the frame. To accommodate installation of the clip, the disclosed invention utilizes a split body and double spine arrangement that permits in-plane deflection of the base which draws the hook back from the lip of the C-section. Once released, both base sections spring back to their natural positions. Orienting the hooks to face in opposite directions prevents inadvertent dislodging of the clip due to pressure upon one side, as that naturally causes increased pressure and contact of the opposite hook with the frame, and consequently retention.

The smaller restrict tab provides for restricting motion of the clip, and therefore naturally the bar itself, along the length of the frame. It is a small preferably rigid plastic piece extending downwardly from the underside of each base section. It is typically situated near or adjacent to the hook pieces, but may be anywhere in relation to the hook on the underside of the base section. Although in a preferred embodiment, the smaller tab will be an entirely separate piece, in an alternative embodiment, the tab and the hook may be connected by a small plastic perpendicular piece, further strengthening the grip that the clip has on the window frame.

### BRIEF DESCRIPTION OF THE DRAWINGS

FIG. 1 shows a front side perspective view of the preferred embodiment of the muntin clip of the present invention.

FIG. 2 shows a bottom perspective view of the muntin clip of FIG. 1.

FIG. 3 shows a front view of the muntin clip of FIG. 1.

FIG. 4 shows a side view of the muntin clip of FIG. 1.

FIG. 5 shows a rear view of the muntin clip of FIG. 1.

FIG. 6 shows a bottom view of the muntin clip of FIG. 1.

FIG. 7 shows a side cross sectional view of the muntin clip of FIG. 1.

FIG. 8 shows a perspective view of the muntin clip of FIG. 1 and a space frame provider into which the clip is to be installed.

FIG. 9 shows a perspective view of the muntin clip of FIG. 1 being installed into a space frame provider.

FIG. 10 shows a perspective view of the muntin clip of FIG. 1 installed in a space frame provider.

FIG. 11 shows a side front perspective view of an alternate embodiment of the muntin clip of the present invention.

FIG. 12 shows a bottom perspective view of the muntin clip of FIG. 11.

FIG. 13 shows a front view of the muntin clip of FIG. 11.

FIG. 14 shows a bottom view of the muntin clip of FIG. 11.

FIG. 15 shows a side view of the muntin clip of FIG. 11.

FIG. 16 shows a side cross sectional view of the muntin clip of FIG. 11.

FIG. 17 shows a perspective view of the muntin clip of FIG. 11 and a space frame provider into which the clip is to be installed.

FIG. 18 shows a perspective view of the muntin clip of FIG. 11 being installed into a space frame provider.

FIG. 19 shows a perspective view of the muntin clip of FIG. 11 installed in a space frame provider.

### DETAILED DESCRIPTION OF THE PREFERRED EMBODIMENTS

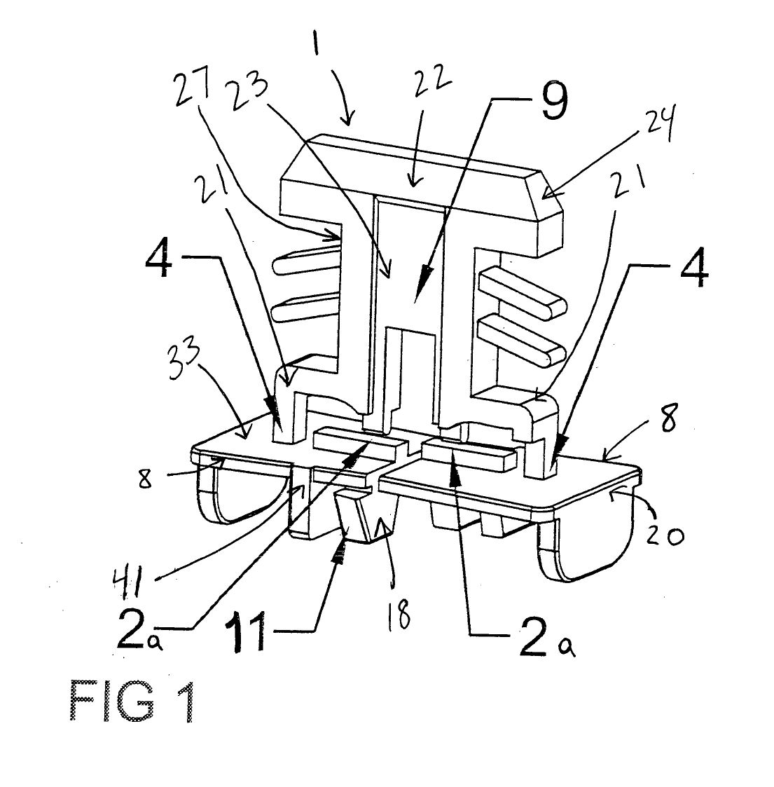

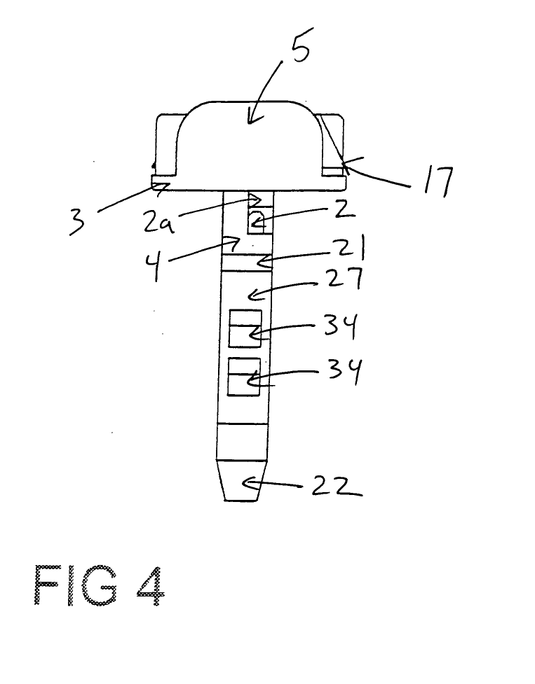

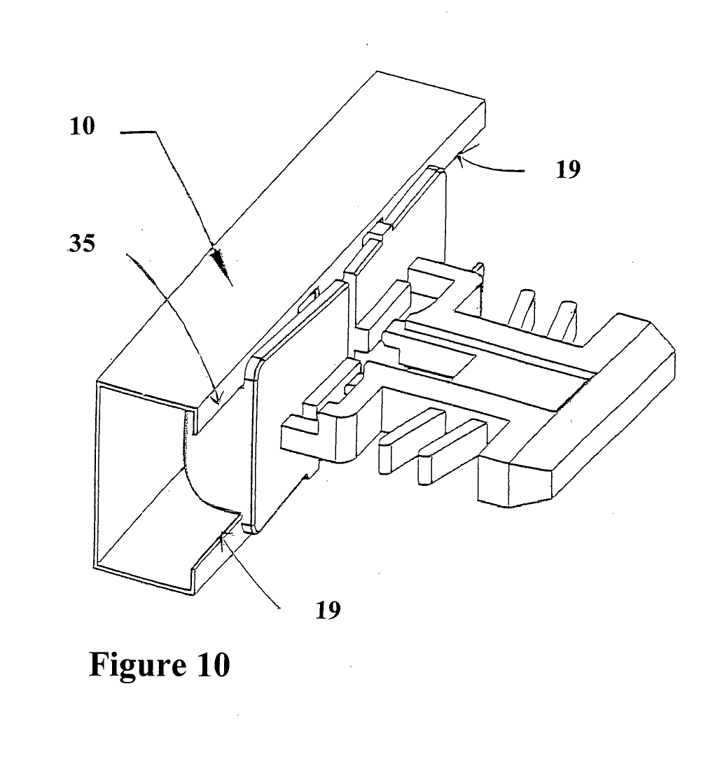

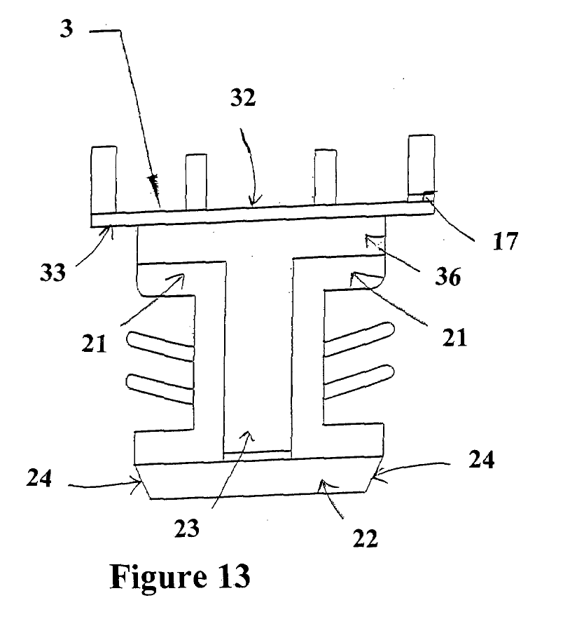

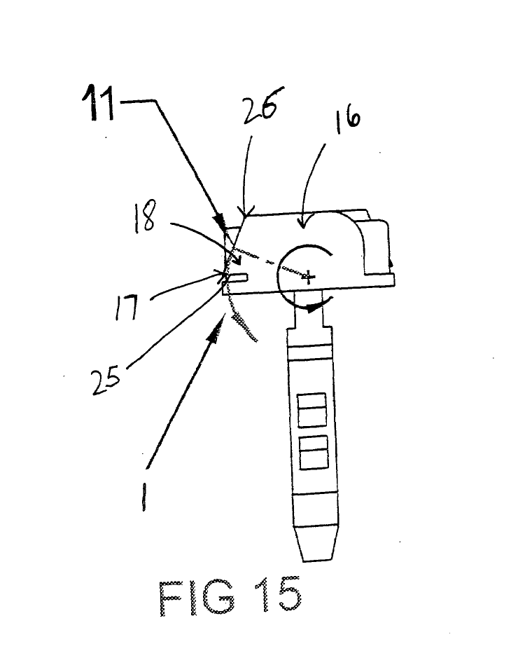

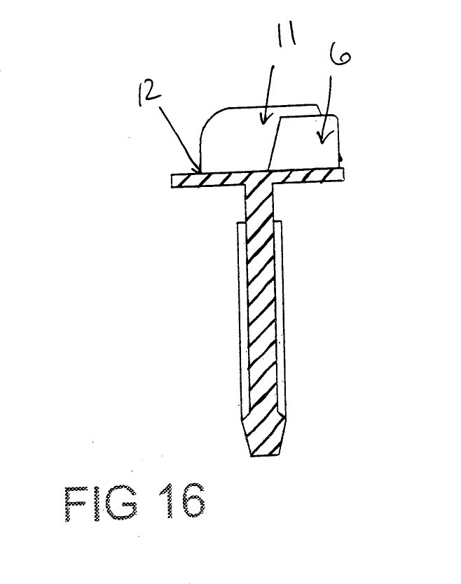

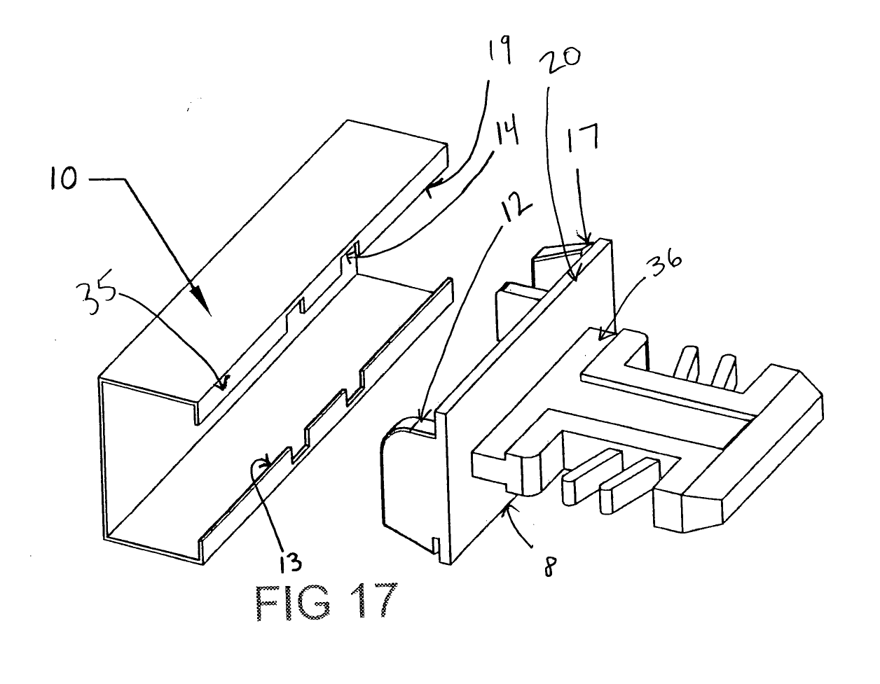

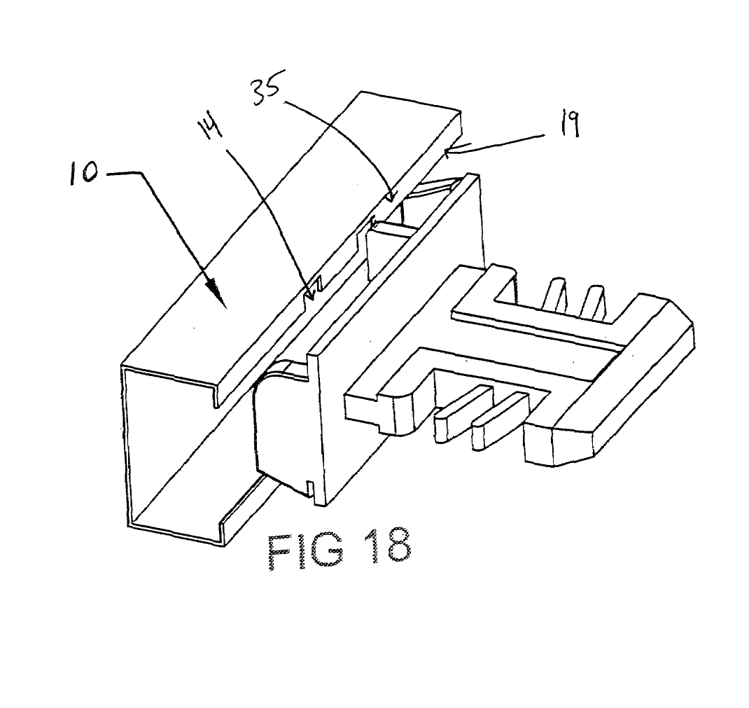

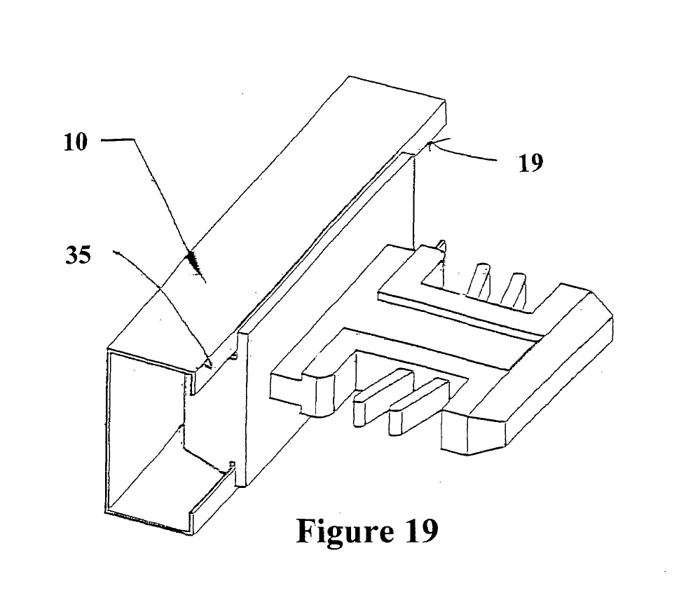

As illustrated by FIGS. 1-20, a tubular muntin bar (not pictured) is connected with a space frame provider, or spacer 10 that separates two panes of glass. The clip 1 detachably connects the tubular muntin bar with the spacer 10. The clip latches into the opening provided between the flanges 35 of the spacer 10.

The clip 1 may have at least one intermediate plate 3, preferably two, a set of fasteners 11, also preferably two, that are projected from the bottom surface 32 of each intermediate plate 3, a bar plug 9 that extends outwardly from the top surface 33 of each intermediate plate 3, at least one tab, preferably two, 5 and 6 projecting from the bottom surface 32 of each intermediate plate (giving at least two tabs overall on the clip), and one or more sets of lateral ribs 34 projecting from the side surface 27 of the bar plug 9 and inclined toward the nearest intermediate plate 3. In the preferred embodiment of the present invention, though, as illustrated by Figures 1-10, the clip 1 has two intermediate plates 3, each with a fastener 11 projecting from its bottom surface 32, a bar plug 9, one larger outer tab 5 projecting from the bottom surface 32 of each intermediate plate, one smaller inner tab 6 projecting from another point on each intermediate plate, and two pairs of lateral ribs 34 projecting from the side surface 27 of the bar plug 9, each pair inclined toward the nearest intermediate plate 3. The outer tab 5 is optionally present.

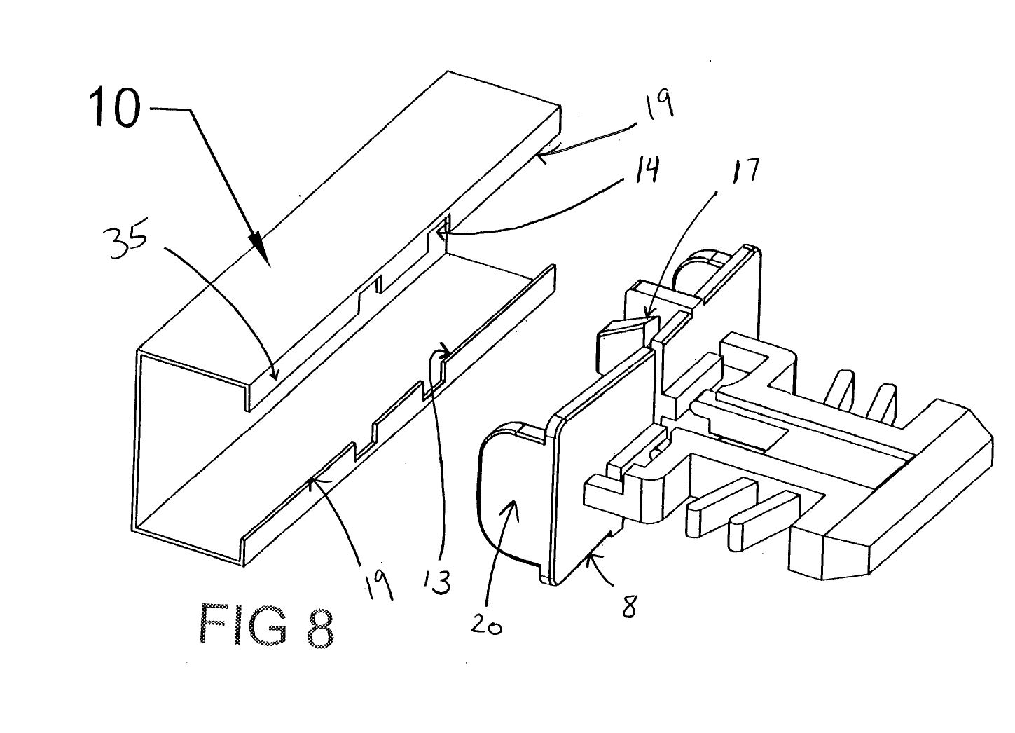

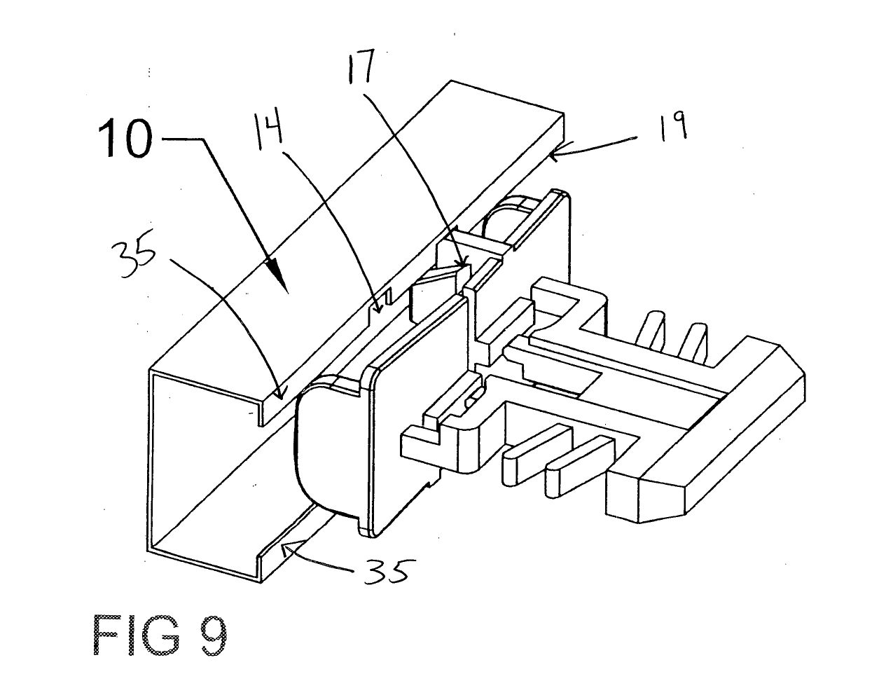

As seen in FIGS. 8 and 9, small rectangular notches 14 may be formed in the flanges 35 of the spacer 10 to receive the inner tabs 6 of the clip 1 and thus to provide fixed positioning of the clip 1 on the spacer 10. In the preferred embodiment, these inner tabs 6 serve the purpose of restricting movement of the clip 1 along the flanges 35 of the spacer 10. However, in alternate embodiments, the inner tabs 6 may serve a different purpose in relation to securing the clip 1 to the spacer 10. The notches 14 are relatively small and do not extend the full depth of the flanges 35 of the spacer 10. The spacer 10 may have multiple sets of flange notches 14, but preferably it has two pairs of flange notches 14. If the spacer 10 has one pair of notches at each edge, then such notches may be positioned on the opposite flanges 35 of the spacer 10 generally diagonally to each other at such part of the flanges 35 of the spacer 10 where muntin bars are to be attached. Positioning and amount of such notches 14 along the spacer 10 may depend on the configuration of the fasteners 11 and the amount of the muntin bars to be positioned on the spacer 10.

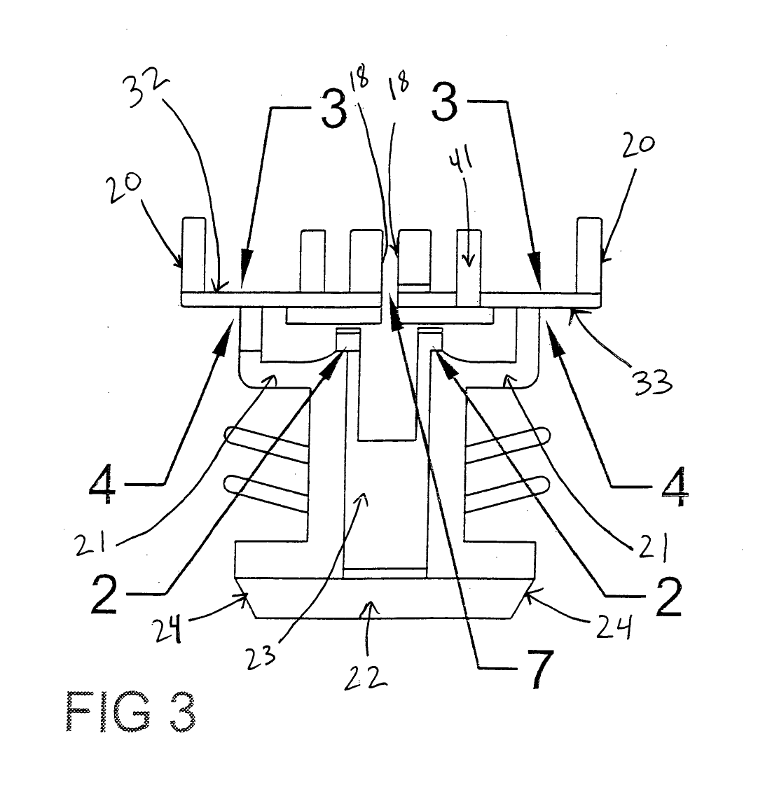

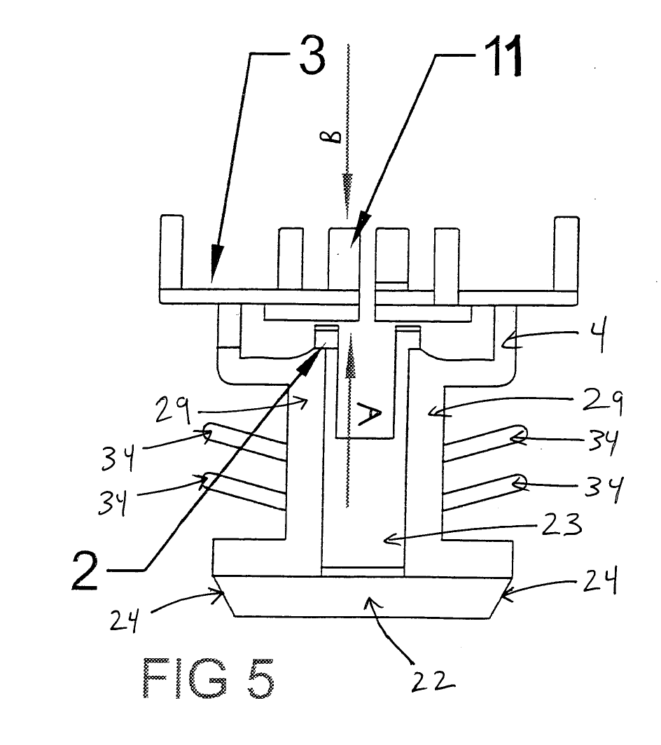

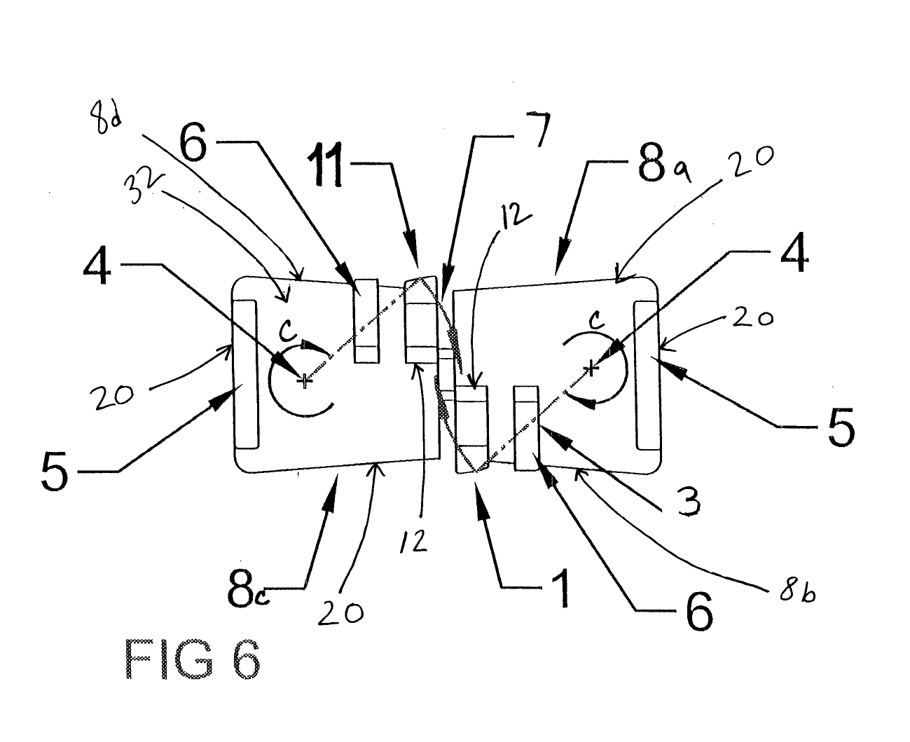

In the preferred embodiment, the clip 1 of the present invention utilizes two separate intermediate plates 3, which are connected to the bar plug 9 by a pair of leg-like members 4, as shown in FIG. 5. Although the intermediate plates 3 may be attached rigidly to the bar plug 9, in the preferred embodiment, the plates 3 are flexibly connected, and may be rotated around the axis of each leg member 4 to assist in placement of the clip 1 into the spacer 10 for installation of the muntin bars. Indeed, because of a gap 7 between each plate 3, the plates may even be pressed toward each other to disengage them from the spacer 10. Furthermore, although the plates 3 may differ in shape and size, they are preferably identical to each other. Although it may be any shape, in the preferred embodiment, each plate 3 is preferably generally rectangular in shape, with bevel edges 8, meaning that the width of the plates is greater on one side than on the other. However, in the preferred embodiment, as shown in FIG. 6, edges 8a and 8c are parallel, and edges 8b and 8d are parallel, facilitating easier insertion of the clip 1 into spacer frame 10. Although bevel edges 8 are not all parallel to each other, each intermediate plate, in the preferred embodiment, as shown in FIG. 3, have outer end edges 20 and inner end edges 18, which are generally parallel to each other to provide proper alignment of the clip 1 along spacer frame 10. The plate 3 has an bottom surface 32, from which protrudes the tabs 5 and 6 and the fasteners 11 disclosed herein, an top surface 33, which is connected to the bar plug 9 disclosed herein, and a sidewall connecting the inner and bottom surfaces 32 and 33, respectively.

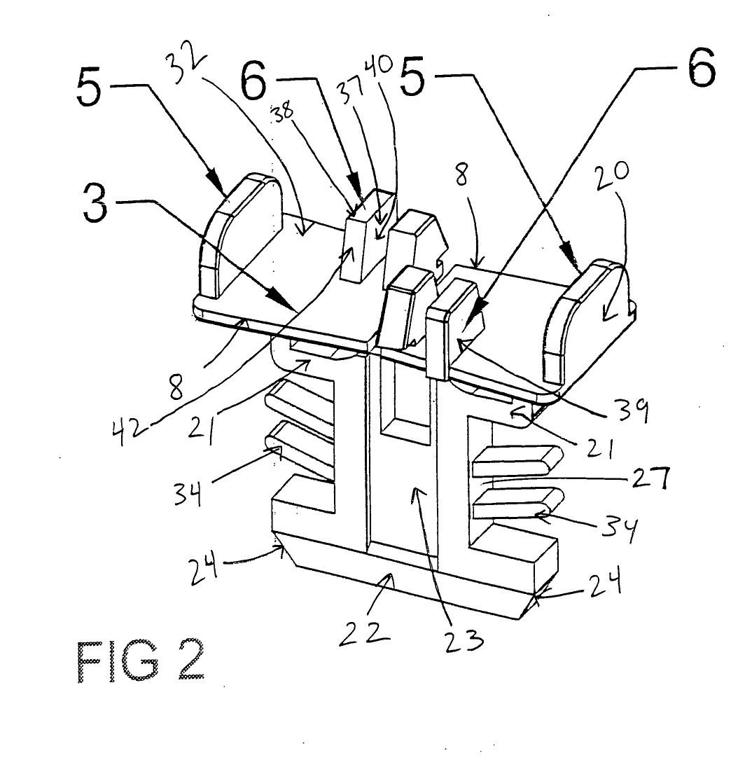

It should be noted that the tabs 5 and 6 of the clip 1 may be generally any shape or size and may even be identical in size and shape. Moreover, tabs 5 and 6 may be situated anywhere along the bottom surface of the intermediate plate 3. In light of this, the following paragraph details the preferred embodiment of the present invention as illustrated by FIGS. 1-10, but should not be read as limiting on the possible embodiments of the present invention. The width of the outer tabs 5 projecting from the bottom surface 32 of each intermediate plate 3 is preferably slightly narrower than the distance between edges 19 of the flanges 35 of the spacer 10 because such configuration would allow the clip 1 to be aligned with the spacer 10 and therefore, for the muntin bar to be properly positioned relative to the spacer 10. The outer tabs 5 may be semi-circular or semi-rectangular in shape. Inner tabs 6, on the other hand, are preferably generally about the same size as the fasteners 11, with the only difference between the fasteners 11 and the inner tabs 6 being the fact that whereas only one end 12 of each fastener is fixed to the bottom surface 32 of the intermediate plates 3, both ends of the inner tab 6 are secured to the bottom surface 32 of the intermediate plates 3. Each inner tab preferably has a body 37, as shown in FIG. 2, with a top surface 38, generally two side surfaces, 39 and 40, a front surface 41 and a rear surface 42. In the preferred embodiment illustrated by FIG. 2, it should be noted that the front surface 41 of inner tab 6 extends outward from edge 8, providing a more secure restriction of the clip 1 along spacer flange 35. Furthermore, in the preferred embodiment, each inner tab 6 is situated on the same edge 8 of the intermediate plate 3 as the fastener 11 adjacent to which it is fixated. In alternate embodiments, however, the inner tab 6 may just as easily be situated anywhere else along the bottom surface 32 of the intermediate plate 3 in relation to the fastener 11. For instance, in one alternate embodiment, the tab is projected from the edge 8 opposite the one nearest the fastener 11. Additionally, the inner tabs 6 and the fasteners 11 may either be separate pieces entirely, as is shown in FIGS. 1-10, or, they may be connected by a horizontal bridge piece, in an alternative embodiment not shown. The bridge piece will preferably be roughly perpendicular to the inner tab 6 and the fastener 11, and will preferably extend from either the side or the rear of one piece to the side or rear of the other piece.

For aesthetic purposes, the distance between the edges 8 of each intermediate plate 3 preferably would not exceed the width of the spacer 10, because in such embodiment, when the clip 1 is positioned on the spacer 10, the edges 8 of each intermediate plate 3 would not extend over the spacer 10. Thus, if the muntin bar has the same width as spacer 10 which is very common for insulating glass units, once the muntin bar is positioned on the clip 1, the edges 8 of each intermediate plate 3 would be coincident with the width of the spacer and thus, the clip would be completely hidden from view.

Lateral restrict inner tabs 6 of the clip may be embedded into the notches 14 made in the spacer 10, thus preventing movement of the clip 1 along spacer 10. Outer tabs 5, on the other hand, would provide the alignment along the spacer 10. The extending fasteners 11 may provide fixed positioning of the clip 1 on the spacer 10. It will be shown that the tips 17 of the fasteners 11 may extend beyond edges 19 of the flanges 35 spacer 10 underneath of such edges, securing flanges 35 between tips 17 and bottom surface 32 of each intermediate plate 3 thus providing outward fixed positioning of the clip 1 relative to the spacer 10.

The fasteners 11 may be embodied as relatively narrow strips of preferably rigid plastic material that extend outwardly from the bottom surface 32 of each intermediate plate 3. At some point, initially generally perpendicular to the bottom surface 32 of the plate 3, the direction of the fastener 11 may be changed approximately at the middle of its entire length and at approximately 90 degrees forming the tip 17 that secures the intermediate plate 3 of the clip 1 of the flanges 35 of the spacer 10. It will be shown that such shape of the fastener may provide better support of such fastener when it is positioned upon the spacer 10.

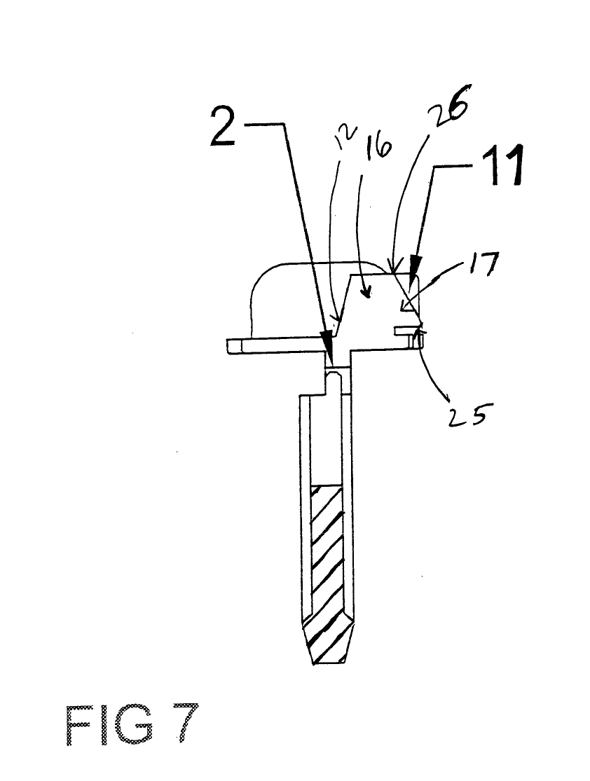

As illustrated in FIG. 7, the extending fastener 11 may have a fixed end 12, a body member 16, and a tip 17. The tip 17 may have an upper edge 26 and a lower edge 25. The fixed ends 12 of the fasteners 11 may extend from the bottom surface 32 of the intermediate plates 3 at any place, but such place may depend upon desired effects of such placement. For instance, in one embodiment, the depth and configuration of the notches 14 of the spacer 10 may determine the placement of the fixed end 12 of the fastener 11 along the bottom surface of the intermediate plate 3. In this embodiment, the deeper the notches made from the edges 19, the closer to the edges 8 of each intermediate plate 3. Such correlation between the configuration of the notches 14 and the positioning of the fixed ends 12 relative to the bottom surfaces 7 of the intermediate plates 3 of the clip 1 may be explained by the fact that, in this embodiment, both fixed ends 12 of the intermediate plates 3 are embedded into notches 14, to generally align the clip 1 in a fixed position along the spacer 10. As was mentioned above, although various shapes of fastener 11 may be used, in the preferred embodiment, the fastener 11 is preferably L-shaped in general, with a suspended arm 18 formed at a right angle to the fastener's body member 16. In alternate embodiments, the fastener 11 may assume a different shape, such as the shape of a generally right angle elbow formed on the fastener's body member 16. The location of such elbow relative to the length of the fastener's body 16 may be at any place within such length, but in the preferred embodiment, such elbow is generally in the middle of the fastener's body.

While the body 16 of each fastener 11 is firmly attached to the bottom surface 32 of each intermediate plate 3, the tip 17 of the fastener should be preferably suspended. The tip 17 of the suspended arm 18 of the fasteners 11, may be configured in any shape, but, in the preferred embodiment, it is generally in the shape of a right triangle and preferably tapered outwardly from the intermediate plate 3 in such manner that the tip's 17 thickness gradually increases from the lower edge 25 of the tip 17 toward the upper edge 26 of the tip 17. The fasteners 11 may be configured in such way that the distance between the lower edges 26 of both tips of fasteners 11 is approximately equal to or less than the width of the gap between the edges 19 of the flanges 35 of the spacer 10 and the distance between upper edges 25 of the tips 17 of the fasteners 11 is slightly larger than the width of the gap between the edges 19 of the spacer 10. In such configuration, when the clip 1 is pushed toward the spacer 10, the fasteners 11 would enter the gap between edges 19 of flanges 35 of the spacer 10. Also, it is preferred that there be a space provided between the upper edge 26 of the tip 17 of the fastener 11 and the bottom surface 32 of the intermediate plates 3 of the clip 1 and the width of such space is preferably equal or slightly larger then the thickness of the flanges 35 of the spacer 10. It would allow the tips 17 of the fasteners 11, as they passed through the opening between edges 19 of the flanges 35 of the spacer, to catch the top surface 13 of the flanges 35 of the spacer 10. At this point, the upper edges 25 of the tips 17 would bear against the top surface 13 of the flanges 35 of the space frame provider 11 trapping the flanges 35 between the upper edges 25 of the tips 17 and the bottom surface 32 of the intermediate plates 3 of the clip 1 and as result, fixedly positioning the clip 1 on the spacer 10.

While one end 12 of the fastener 11 is firmly attached in generally perpendicular direction to the bottom surface 32 of the intermediate plate 3, the tip 17 of the fastener may be suspended in order to catch the edge 19 of the spacer 10. While the fasteners 11 may be flexible, in the preferred embodiment, they are constructed of a rigid plastic material that provides support when pressure is placed on the clip in an outward direction and is not bendable. This is because, in the preferred embodiment, the plates 3 have a flexible connection to legs 4 necessary to facilitate installation or removal of the clip of the present invention. Thus, by making the leg-plate connection a flexible one, the need for a flexible fastener is eliminated. The positioning of clip 1 upon the spacer 10 is generally conducted in the following way in the preferred embodiment: At the moment of insertion of the clip 1 into spacer 10, the tip 17 of fastener 11 is slightly depressed by the flange 35 of spacer 10 at one side of the intermediate plate 3; the plate 3 is then flexibly twisted around the axis of leg 4 in rotational direction C, as FIG. 6 shows. A force is placed simultaneously on the intermediate plates 3 in the A direction, as illustrated by FIG. 5, in order to complete insertion of the clip 1. Upon insertion, the clip 1 is fixed into position within spacer 10 by the simultaneous restriction of the clip 1, by outer tabs 5 (forward and backward restriction), 6 (lateral restriction), and fasteners 3 which prevents removal of the clip 1 when a force is placed in the B direction, as is illustrated in FIG. 5.

The bar plug 9 is preferably a flat rectangular or square plate-like member that may have at least one upper cross-member 22, a central rib 23, with at least two sets of lateral ribs 34, and, preferably, at its bottom, a split spine 29, ending in at least one lower cross member 21. In the preferred embodiment, the central rib 23 extends between the upper cross member 22 and the split spine 29. Although, only one lower cross member 21 may be utilized in the present bar plug, in the preferred embodiment illustrated by FIGS. 1-10, at least two lower cross members, which resemble thighs 21 in relation to each leg 4, are utilized. Each thigh 21 preferably has two vertical members 2 and 4 extending downwardly from the bottom surface of the cross member in the direction of the intermediate plate. In the preferred embodiment, one of these vertical members is an leg 4, which is connected at one end to the intermediate plate 3 and is connected at the opposite end with the thigh 21. The vertical support bar 2, in the preferred embodiment serves the purpose of restricting movement of the flexible intermediate plate 3 upward further than the point at which the intermediate plate 3 contacts the vertical support bar 2. The other vertical member is preferably a support bar 2, which is preferably only connected to either the intermediate plate 3 or the thigh 21, but not both. In the preferred embodiment, there is also a horizontal support bar 2a which, as shown in FIGS. 1 and 3, takes the form of a horizontal rectangular bar resting on the intermediate plate 3. This horizontal support bar 2a is preferable, but in alternate embodiments, it is not present. Moreover, while in the illustrated embodiments of FIGS. 1-10 the horizontal support bar 2a is present on the intermediate plate 3 and the vertical bar 2 is connected with thigh 21, alternatively, the horizontal support bar 2a may extend from the thigh 21 and the vertical bar 2 may be connected to the intermediate plate 3.

The lateral edges 24 of the upper cross member 22 are tapered away from the intermediate plates 3 for easier positioning of the muntin bar upon the clip 1. Because this embodiment facilitates insertion of the bar plug 9 into the end of the hollow muntin bar, the width of the cross members 21 and 22 be preferably approximately equal to the width of the cross-section of the muntin bar in order for the side edges of the cross members 21 and 22 to bear against the inside surfaces of the walls of the muntin bars to hold the bar plug 9 firmly inside the muntin bar. Moreover, when the bar plug 9 is inserted into the open end of the muntin bar, the lateral ribs frictionally engage the top surface of the walls of the muntin bar and secure it to the clip 1.

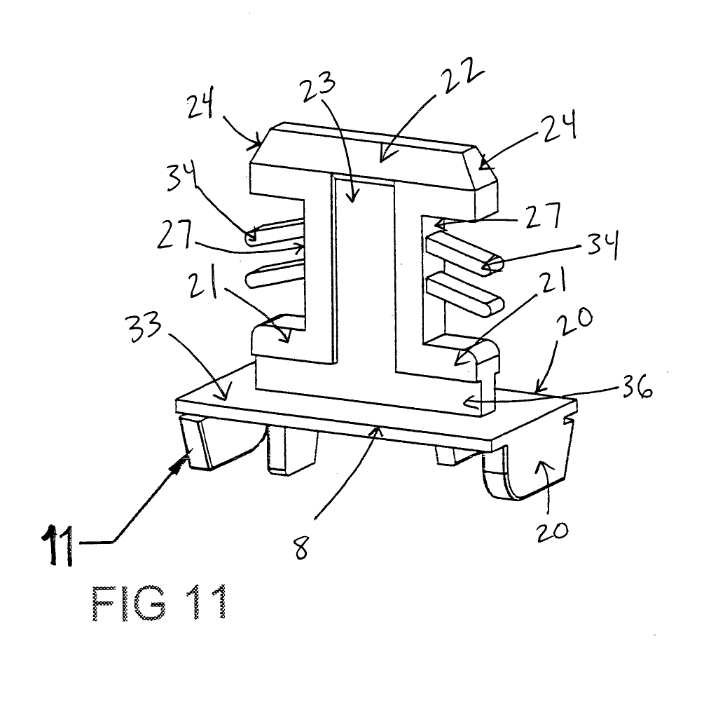

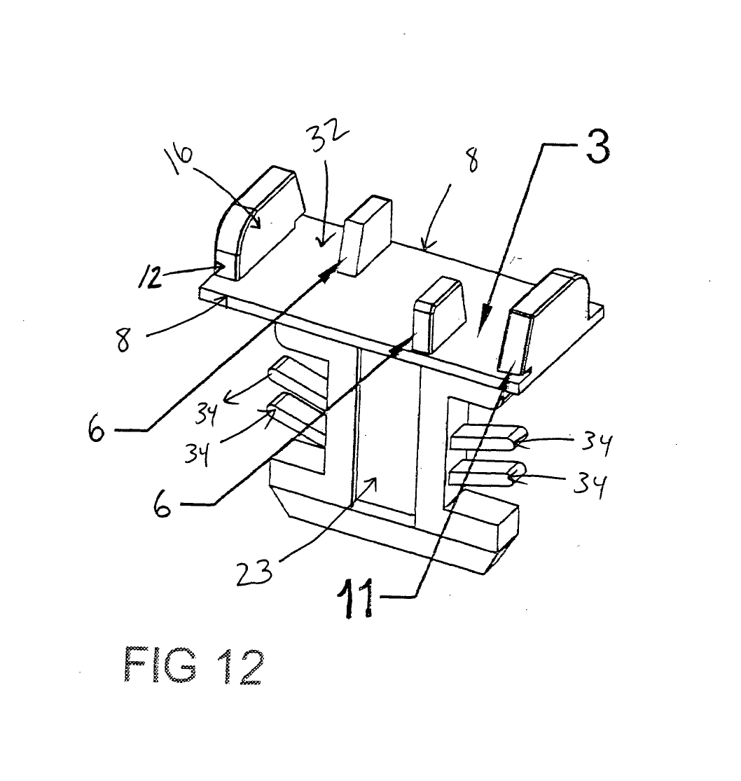

In an alternate embodiment, as illustrated by FIGS. 11-19, the clip 1 of the present invention is situated slightly differently from the preferred embodiment illustrated by FIGS. 1-10. In this embodiment, the clip 1 of the present invention is characterized by a bar plug 9 and one intermediate plate 3. The bar plug in this alternate embodiment comprises an upper cross member 22, central rib 23, with side surfaces 27, two pairs of lateral ribs 34 connected to side surfaces 27, one lower cross member 27, and a horizontal bar 36 which connects the bar plug 9 to the intermediate plate 3. The intermediate plate is characterized as generally rectangular in shape, with an top surface 33, and an bottom surface 32. On the bottom surface 32, as is illustrated by FIG. 12, there are two inner tabs 6 of equal size on opposite edges of the intermediate plate and two fasteners 11, situated similarly to outer tabs 5 in the previous embodiment. In this embodiment, however, since the fasteners 11 are situated in the same spot as the fasteners 5 of the previous embodiment, they serve a dual purpose. The fasteners 11 not only secure the clip 1 into the spacer by securing the flange 35 in between the upper surface 26 of the fastener and the bottom surface 32 of the intermediate plate 3, but the fasteners also restrict movement of the clip 1 forward and backward within the spacer 10. Furthermore, the intermediate plate 3 is still flexibly connected to the horizontal bar 36, creating an ability to bend the plate 3 during installation and removal.

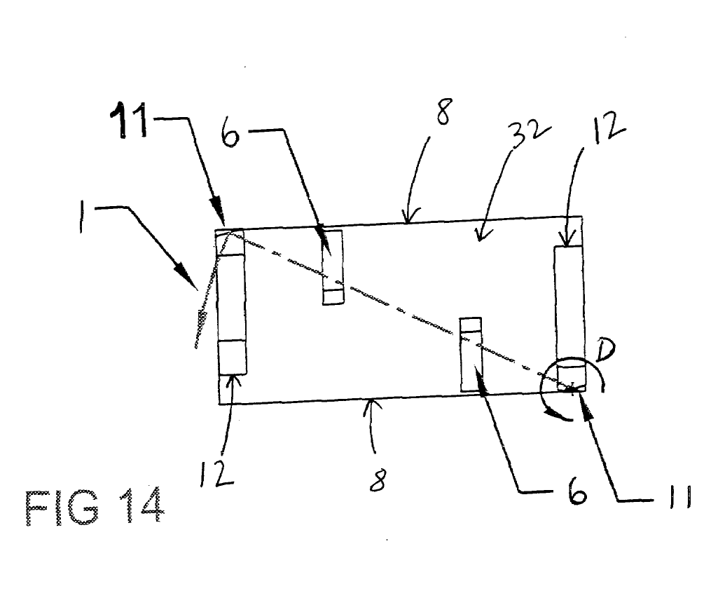

The clip 1 of the embodiment illustrated by FIGS. 11-19 is installed in the spacer 10 like so: A user first inserts one of the fasteners 11 at one end of plate 3 into spacer 10. Then the user presses the other fastener 11 downwardly, causing the plate 3 to be deformed as a twist force in rotational direction D is exerted on the fastener 11 that is first inserted, as illustrated by FIG. 14. Finally, the fasteners 11 are fixed into position within spacer 10. The clip 1 is thus secured within the spacer 10 by simultaneous restriction on the part of fasteners 11, which prevent movement of the clip forward, backward and upward, and inner tabs 6, which prohibit lateral motion of the clip 1.

Although only certain embodiments of this invention has been in details described above, those skilled in the art will readily appreciate that many modifications of the exemplary embodiment are possible without materially departing from the novel teachings and advantages of this invention. All such variations and modifications intended to be included within the scope if this invention as defined in the claims.

Other modifications, substitutions, omissions and changes may be made in the design, size, materials used or pro portions, operating conditions, arrangement or positioning of elements and members of the preferred embodiment without departing from the spirit of this invention as described in the claims.

I claim:

1. A clip for securing a muntin bar to a spacer frame member of an insulating glass unit, said clip comprising:
said spacer frame member having a first and second spacer flange, said spacer flanges forming an opening for receiving said clip;
a first intermediate plate and a second intermediate plate, each of said plates having a top surface and a bottom surface;
said first plate having a first leg extending from said top surface of said first plate and said second plate having a second leg extending from said top surface of said second plate said first and second legs ending in a center rib;
said rib being adapted to be received by a muntin bar;
said first plate having a first fastener extending from the bottom surface of said first plate, said first fastener securing said clip to said spacer frame, said first plate further comprising a first tab extending from the bottom surface of said first plate said first tab being adapted to be received by a notch in said spacer frame without securing said clip to said spacer frame, said first fastener securing said clip to said spacer frame;
said second plate having a second fastener extending from the bottom surface of said second plate, said second fastener securing said clip to said spacer frame, said second plate further comprising a second tab extending from said second plate, said second tab being adapted to be received by a notch in said spacer frame without securing said clip to said spacer frame.

2. The clip according to claim 1 wherein said fastener and said tab are rigid.

3. The clip according to claim 1 wherein said fastener comprises a body and a tip, said tip having an upper surface, said flange being adapted to be received by said clip between said upper surface of said tip and the bottom surface said respective plate.

4. The clip according to claim 3 wherein said tab has a body extending from said plate, said body having a front surface extending outwardly of a side of said plate.

5. The clip according to claim 4 wherein at least one of said plates has an outer end edge and an inner end edge that are joined by first and second side edges.

6. The clip according to claim 5 wherein each of said plates has an outer end edge and an inner end edge that are joined by first and second side edges.

7. The clip according to claim 6 wherein said end edges are generally parallel to each other.

8. The clip according to claim 7 wherein the first side edge of said first plate is parallel to the second side edge of said second plate.

9. The clip according to claim 8 wherein the second side edge of said first plate is parallel to the first side edge of said second plate.

10. The clip according to claim 9 wherein said first plate has an outer tab extending from the bottom surface of said plate adjacent said outer edge of said plate.

11. The clip according to claim 10 wherein said second plate has an outer tab extending from the bottom surface of said plate adjacent said outer edge of said plate.

12. The clip according to claim 11 wherein said leg is connected to said rib by means of a generally horizontal thigh.

13. The clip according to claim 12 wherein said rib has a vertical support bar extending from the portion of said rib adjacent said thigh.

14. The clip according to claim 13 wherein said vertical support bar contacts a horizontal support bar on the top surface of said plate when said clip is inserted into said spacer bar.

15. The clip according to claim 13 wherein said vertical support bar is spaced apart from a horizontal support bar extending along the top surface of said plate.

16. A clip for securing a muntin bar to a spacer frame member of an insulating glass unit, said clip comprising:
said spacer bar having a first and second spacer flange, said spacer flanges forming an opening for receiving said clip;
an intermediate plate having a top surface and a bottom surface;
said plate having a horizontal bar extending from said top surface of said plate ending in a center rib;
said rib being adapted to be received by a muntin bar;
said plate having a first and second fastener extending from the bottom surface of said plate, said first and second fasteners securing said clip to said spacer frame, said plate further comprising a first and second tab extending from the bottom surface of said plate said tabs being adapted to be received by a notch in said spacer frame without securing said clip to said spacer frame, said fasteners securing said clip to said spacer frame.

17. The clip according to claim 16 wherein said fastener and said tab are rigid.

18. The clip according to claim 16 wherein said fastener comprises a body and a tip, said tip having an upper surface, said flange being adapted to be received by said clip between said upper surface of said tip and the bottom surface said respective plate.

19. The clip according to claim 18 wherein said tab has a body extending from said plate, said body having a front surface extending outwardly of a side of said plate.

20. The clip according to claim 19 wherein said outer tab extends from the bottom surface of said plate adjacent an outer edge of said plate.
